(19) United States
(12) Patent Application Publication
(10) Pub. No.: US 2023/0331890 A1
(43) Pub. Date: Oct. 19, 2023

(54) COMPOSITION AND PRODUCTION METHOD FOR 3D PRINTING CONSTRUCTION MATERIAL

(71) Applicant: Mighty Buildings, Inc., Oakland, CA (US)

(72) Inventors: Guzel Kirsankina, Linogorsk (RU); Sergei Naumov, Moscow (RU); Evgenii Ostanin, Novosibirsk (RU); Petr Brevnov, Troitsk (RU); Anna Fedosova, Moscow (RU); Maxim Bogdanchikov, Moscow (RU); Elizaveta Sovdagarova, Moscow (RU); Ivan Diasamidze, Novi Sad (RS); Dmitry Grachev, Moscow (RU); Petr Nezhny, Moscow (RU)

(21) Appl. No.: 18/198,810

(22) Filed: May 17, 2023

Related U.S. Application Data
(63) Continuation-in-part of application No. 17/824,697, filed on May 25, 2022.
(60) Provisional application No. 63/193,054, filed on May 25, 2021.

(51) Int. Cl. C08F 222/10; B29B 7/00; C08F 2/50; C08K 7/20; C08K 7/14

(52) U.S. Cl. CPC C08F 222/1025; B29B 7/002; C08F 2/50; C08K 7/20; C08K 7/14; B33Y 70/00

(57) ABSTRACT

A composition of 3D printable photocurable material can include acrylate monomer(s) between about 0-30.0 composition wt %; acrylate oligomer(s) between about 0-30.0 composition wt %; photoinitiator(s) between about 0.02-1.0 composition wt %; chopped fiber(s) between about 0.1-3.0 composition wt %; flame retardant(s) between about 2.0-20.0 composition wt %; processing aid(s) between about 0.05-3.0 composition wt %; additive(s) between about composition 0-3.0 wt %; and filler(s) between about 20.0-80.0 composition wt %. The composition can have a viscosity of about 10,000-300,000 mPa·s, can be configured to be extruded at a printing speed of about 7-90 cm³/s during 3D printing, can be photopolymerized under UV or visible irradiation at a material depth of about 4-8 mm, and can be cured to form a building construction material.

### CROSS-REFERENCE TO RELATED APPLICATIONS

This application is a continuation-in-part of and claims priority to commonly owned U.S. patent application Ser. No. 17/824,697, filed May 25, 2022, which in turn claims priority to commonly owned U.S. Provisional Patent Application No. 63/193,054, filed May 25, 2021, both applications being titled “COMPOSITION AND PRODUCTION METHOD FOR 3D PRINTING CONSTRUCTION MATERIAL,” and both applications being incorporated by reference herein in their entireties.

### TECHNICAL FIELD

The present disclosure relates generally to 3D printing, and more particularly to compositions and methods of production of 3D printing construction materials.

### BACKGROUND

Three-dimensional (“3D”) printing, also known as additive manufacturing, is a technique that deposits materials only where needed, thus resulting in significantly less material wastage than traditional manufacturing techniques, which typically form parts by reducing or removing material from bulk material. Recently, 3D-printed articles were generally models; the industry is rapidly evolving these days, creating 3D-printed articles that may be functional parts in more complex systems, such as hinges, tools, and structural construction elements.

In existing 3D printing processes, a 3D object is created by forming layers of material under computer control without molding. For example, 3D information of a structure is determined using computer 3D modeling fragmentation, and the mixture prepared for printing the structure can be fed from a nozzle using a mechanical control based on 3D modeling.

The modern construction industry is facing a shortage of 3D printing materials that meet the requirements and standards of the industry. For example, existing 3D printing materials are mainly thermoplastics. The thermoplastics are printed in a molten state at a high temperature via layer-by-layer deposition. The need to use high temperatures for 3D printing with thermoplastic material limits the scalability of 3D printing of thermoplastics for the printing of large building panels or residential buildings. Power consumption for melting thermoplastics is high, and parts in a printer should be manufactured using a material enduring high temperature, thereby causing an unnecessary increase in production costs. Other disadvantages of thermoplastics are high creep and low long-term strength.

Cement or geopolymer-based concrete is another example of printing material.

To meet the industry's requirements, cementitious materials for extrusion-based printing must have contradictory rheological properties. For example, to carry its own weight, concrete must have high compressive and shear strengths, and the water-to-cement ratio should be as low as possible. However, a specific water content must be maintained for the concrete to be workable. Concrete must have a fluid consistency, but it must also be able to keep the extruded layer form and withstand further layers' weight. Finally, when extruded, the mixture should dry as soon as possible, yet keep its wetness for a long enough time to provide bonding with the next layer, rather than drying altogether.

Concrete 3D-printed buildings cannot fully utilize the power of 3D printing and all of its benefits. A concrete wall with relevant performance for construction requires a complex assembly of various materials and involves a multitude of processing steps. As structural material concrete provides good compressive strength, however, it does not show satisfying characteristics under tension. Due to building code constraints, 3D-printed concrete walls serve as a formwork mostly and still need to be reinforced (typically with metal but not always with rebar) and more concrete poured into the internal cavities.

Further disadvantages of using cement-based materials are that print resolution is constrained by material rheology and nozzle dimensions, limiting the achievable print tolerances. These tolerances are often larger than those required for component interfaces and surface finishing in construction applications. This makes post-processing more complicated and time-consuming, causes additional waste, and significantly increases production costs.

3D-printed concrete technology has primarily been used in on-site construction rather than off-site. Concrete is too heavy and fragile to be used in prefabricated buildings. In the meanwhile, off-site construction methods have advantages over on-site methods such as much greater control over the manufacturing process translating into higher quality products. Weather delays can be reduced, automatization tools can be used to their full potential, and supplies can be organized and easily available.

Many prefab companies are harnessing the power of off-site construction and its many benefits. Existing prefab technologies are limited in the variety of surface designs, textures, and finishes. Moreover, materials that are used in subtractive manufacturing are not easy to manipulate into unique shapes or patterns. These flaws can be overcome by 3D printing with a material that meets construction industry criteria while remaining lightweight and durable.

3D printing off-site enables much greater control over the manufacturing process translating into higher quality products. In light of the foregoing, a material that can harness the power of 3D printed technology and modern off-site prefabricated house-building methods need to be developed to take advantage of this technology.

In conventional additive or 3D fabrication techniques, the printing of a three-dimensional object is performed in a stepwise or layer-by-layer manner. In particular, layer formation is performed through the solidification of resin under the action of visible light or UV irradiation. Two techniques are known: one in which new layers are formed at the top surface of the growing object; the other in which new layers are formed at the bottom surface of the growing object. Photochemical curing, also known as photopolymerization, is an inexpensive and efficient method of additive manufacturing.

The main drawback of light-curing is the limited penetration of light into the irradiated material, which gets even more limited in presence of colored, semi-transparent, or opaque additives, which are frequently used to give the material functional properties. In any known layer-by-layer printing process using polymer materials, the polymer matrix embedded with the composition of the filler must allow light penetration depth to be sufficient for a complete layer solidification.

Early efforts to create photopolymer composite materials for a 3D printing system that includes an acrylate oligomer, an inorganic hydrate, a reinforcing filler, and a UV initiator, such as those found in U.S. Pat. No. 11,267,913, for example, identify the need for modification of the composition to extend the storage time of the composition and optimize the flame retardant content. There is also an unmet need for higher material rigidity, strength, and better adhesion to paint and foam. Overcoming these issues and other objectives can be achieved through the various compositions and methods of this disclosure.

Another issue for 3D fabrication techniques can involve shrinkage of a 3D printing material, which can lead to the warping of parts and make it necessary to print additional layers for milling. Warping of a printed detail can lead to the instability of printed models and their cracking due to the accumulated stresses. To eliminate these problems, dimensional parts are printed with fiber reinforcement material. Fiber reinforcement of composite materials is common in industries such as automobiles, aircraft, and civil engineering for improving the overall load capacity of the composite materials. Recent applications in the field of 3D printing include forming complex parts having a primary material matrix reinforced internally with continuous fibers. This can involve 3D printing utilizing continuous fibers embedded within different kinds of material matrices and with a diversity of core compositions, such as that which is found in U.S. Patent Publication No. 2022/0266516, for example. The use of continuous fibers in 3D printing, however, can lead to restrictions for printing complex-shaped parts, overlapped parts, and overhanging parts. Overcoming these issues and other objectives can be achieved through the various compositions and methods of this disclosure.

### SUMMARY

It is an advantage of the present disclosure to provide low-warping photocurable compositions for 3D printing construction materials as well as methods of production for such compositions. In one aspect, the present disclosure relates to photopolymer composite materials for 3D printing of construction components that can meet requirements for material properties such as elastic modulus, strength, and adhesion to paint, foam, and other materials, among other properties. In another aspect, the present disclosure relates to photopolymer composite materials for 3D printing of construction elements such as exterior walls, interior walls, load-bearing exterior walls, structural members, and/or building partitions that can meet requirements of the construction industry such as high stiffness, high strength, lightweight, durability, and low carbon footprint, among other requirements.

Furthermore, the present disclosure provides materials that can be extruded during 3D printing with a printing speed of about 7 to 90 cm^{3/}s, that allow for photopolymerization reactions under UV or visible irradiation to proceed rapidly at a depth of about 4 to 8 mm, that allow for development of composite materials that retains their properties for long storage times (e.g., more than 6 months) before being printed, and that optimize flame-retardant properties of photopolymer composite materials for 3D printing in order to meet requirements for fire-resistance-rated construction and interior flame spread index requirements of the International Building Code, among other favorable characteristics.

In various embodiments of the present disclosure, a composition of 3D printable photocurable material can include one or more acrylate monomers in a range between about 0-30.0 wt % of the composition; one or more photoinitiators in a range between about 0.02-1.0 wt % of the composition; one or more acrylate oligomers in a range between about 0-30.0 wt % of the composition; one or more chopped fibers in a range between about 0.1-3.0 wt % of the composition; one or more flame retardants in a range between about 2.0-20.0 wt % of the composition; one or more processing aids in a range between about 0.05-3.0 wt % of the composition; one or more additives in a range between about 0-3.0 wt % of the composition; and one or more fillers in a range between about 20.0-80.0 wt % of the composition. The composition can have a viscosity of about 10,000-300,000 mPa·s, can be configured to be extruded at a printing speed of about 7-90 cm³/s during 3D printing, can be configured to be photopolymerized under UV or visible irradiation at a material depth of about 4-8 mm, and can be configured to be cured to form a building construction material.

In various further embodiments of the present disclosure, methods of producing a 3D printable photocurable material are provided. Pertinent process steps can include loading a first plurality of components into a mixing device, blending together the first plurality of components in the mixing device to form a premix, adding a second plurality of components to the premix in the mixing device, and mixing together the premix and the second plurality of components in the mixing device. The first plurality of components can include at least one or more acrylate monomers and one or more photoinitiators. The first plurality of components and second plurality of components combined can include at least the one or more acrylate monomers, the one or more photoinitiators, one or more acrylate oligomers, one or more chopped fibers, one or more flame retardants, one or more processing aids, one or more additives, and one or more fillers. Mixing together the premix and the second plurality of components in the mixing device can form a 3D printable photocurable material having a composition. The one or more acrylate monomers can be in a range between about 0-30.0 wt % of the composition, the one or more photoinitiators can be in a range between about 0.02-1.0 wt % of the composition, the one or more acrylate oligomers can be in a range between about 0-30.0 wt % of the composition, the one or more chopped fibers can be in a range between about 0.1-3.0 wt % of the composition, the one or more flame retardants can be in a range between about 2.0-20.0 wt % of the composition, the one or more processing aids can be in a range between about 0.05-3.0 wt % of the composition, the one or more additives can be in a range between about 0-3.0 wt % of the composition, and the one or more fillers can be in a range between about 20.0-80.0 wt % of the composition.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible compositions of material and methods of production for same. These drawings in no way limit any changes in form and detail that may be made to the disclosure by one skilled in the art without departing from the spirit and scope of the disclosure.

FIG. 1 illustrates representative groups of components of 3D printing construction material and major production steps according to one embodiment of the present disclosure.

FIG. 2 illustrates in front perspective view an example 3D-printed panel configured for conducting warpage testing according to one embodiment of the present disclosure.

FIG. 3 illustrates a flowchart of an example method of producing a 3D printable photocurable material according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

Herein, “comprise” and “include” mean that other elements and/or other steps which do not affect the end result can be added. Each of these terms encompasses the terms “consisting of” and “consisting essentially of.”

Herein, “curing” refers to the solidification of the composition as a result of polymerization and crosslinking of acrylate monomers and acrylate oligomers.

Herein, “acrylate monomer” refers to the reactive diluent, the compound with a viscosity up to 500 mPa·s at 25° C. containing acrylate or methacrylate groups capable of radical polymerization.

Herein, “acrylate oligomer” refers to compounds with a viscosity of more than 500 mPa·s at 25° C. containing acrylate or methacrylate groups capable of radical polymerization.

Herein, “(meth)acrylate” refers to both acrylate and methacrylate.

Herein, “photoinitiator” refers to compounds that create reactive species (free radicals, cations, or anions) when exposed to UV or visible light.

Herein, “Type I photoinitiator” refers to compounds that undergo a unimolecular bond cleavage upon irradiation to yield free radicals.

Herein, “Type II photoinitiator” refers to compounds that undergo a bimolecular reaction where the excited state of the photoinitiator interacts with a second molecule (a co-initiator, synergist) to generate free radicals.

Herein, “resin” refers to the liquid part of a composition including acrylate oligomer and acrylate monomer.

Herein, “functionality” refers to the quantity of acrylic or methacrylic groups in a molecule. For example, the term “monofunctional (meth)acrylate” means that a molecule contains one acrylic or methacrylic group.

Herein, “shrinkage” refers to the sum of the volume contraction of composition during curing and cooling to ambient temperature.

Herein, “flame retardant” refers to compounds preventing the combustion of a material. The use of flame retardant in sufficient amounts improves the fire resistance of construction material.

Herein, “fillers” refers to components embedded into the resin to provide enhancement or/and set up mechanical and thermal properties of construction material, with reduced negative post-curing effects such as shrinkage, warpage, and cracking.

Herein, “a coupling agent” refers to substances applied to a filler to increase adhesion to a binder.

Herein, “chopped fiber” refers to fibers consisting of fibrils with a length of 1 to 6 mm.

Herein, “sizing” refers to substances applied to chopped fibers to provide binding the fibrils together, at the same time guarantee the fiber splitting to individual fibrils in the liquid composite as well as matrix-fiber bonding.

Herein, “additives” refers to substances that are added to a composition in small quantities to improve technological properties, storage stability, durability, and strengthening of the material and reduced negative post-curing effects such as shrinkage, warpage, and cracking.

Herein, “thixotropic additives” refer to substances which enhance thixotropy resulting in prevented sedimentation of the fillers.

Herein, “processing aid” refers to substances that ensures the solidity of the flow in combination with the optimal effect of its acceleration, ensures flow integrity at the printing speeds, and ensures the orientation of the chopped fiber in the direction of flow.

Herein, “elastic modulus” refers to both tensile modulus and compression modulus.

Concentrations of various possible components in the composition are given in weight percentage (wt %) units.

The present disclosure relates to photopolymer composite construction materials that meet the requirements of extrusion 3D printing technology and the demands of building construction materials. The disclosed photopolymer composite materials can meet various specific requirements for viscosity, stability to sedimentation, and capability of curing under UV or visible irradiation, among other requirements.

The present disclosure is aimed to the development of 3D printing photocurable compositions showing appropriate flow properties and stability to sedimentation. These factors are associated with composition printability and material stability in storage.

In the present disclosure, printability and stability to sedimentation of the materials can be ensured by choosing a suitable resin and selecting its concentration. In the course of layer-by-layer deposition of the 3D printing material, the resin can be capable of completely saturating the surface of the previously cured layer and forming chemical bonds so that each newly curable layer is firmly fixed to the previous one and provides strong interlayer adhesion strength which is essential for the building material with the load-bearing capacity.

The polymerizable resin used in the developed composite material can be capable of curing in the presence of photoinitiators under UV or visible irradiation. 3D printing of the photocurable composition can have a proper curing rate allowing the extruded layer to keep its shape and capability of bearing sequentially extruded layers.

According to the present disclosure, the chemical composition and content ranges can make it possible to obtain the desired properties of the composite applicable for 3D printing and the final properties of 3D printed parts, such as high rigidity, low deformability, fire resistance, and a fracture resistance, the strength required for load-bearing structures in construction, as well as high adhesion to coating and foam.

The disclosed compositions can have viscosities in the range of about 10,000 to 300,000 mPa·s so that the material can be extruded during 3D printing with printing speeds of about 7 to 90 cm³/s, and can allow photopolymerization reactions under UV or visible irradiation to proceed rapidly at material depths of about 4 to 10 mm.

Other properties of the disclosed compositions and materials can include reduced warping of printed parts, which can allow 3D printing without additional reinforcement, for example, using continuous fiberglass, and at the same time, eliminates the finishing of the dimensions of the printed part (construction board) using mechanical processing, for example, milling.

In a 3D printing process using the disclosed materials and compositions, a 3D printed component can grow by successively laying down and curing one layer of material on top of another. The material can be fed through a pipeline to a nozzle. When flowing in a pipeline, anisotropic fillers can be oriented. In particular, chopped fibers can be oriented in such a way such that the chopped fiber particles are aligned along layers in a cured 3D-printed panel or other component, which can lead to the appearance of anisotropic properties. To reflect the influence of the presence of anisotropic inclusions in the material, Table 1 shows the properties of the material along and across the layers. Here, “along” can refer to the properties along the printed layers, while “across” can refer to properties across all printed layers. Various mechanical characteristics of the resulting 3D-printed construction material are presented in Table 1.

TABLE 1

| Parameter | Value |
|---|---|
| Flexural modulus of elasticity, along, GPa | 3-15 |
| Flexural modulus of elasticity, across, GPa | 3-15 |
| Flexural ultimate strength, along, MPa | 15-50 |
| Flexural ultimate strength, across, MPa | 8-40 |
| Tensile modulus, along, GPa | 3-15 |
| Tensile modulus, across, GPa | 3-12 |
| Tensile strength, along, MPa | 8-25 |
| Tensile strength, across, MPa | 5-15 |
| Compression modulus, along, GPa | 2-12 |
| Compression strength, along, MPa | 40-80 |
| Compression modulus, across, GPa | 2-12 |
| Compression strength, across, MPa | 40-80 |
| Impact resistance Izod, kJ/m², along | 1.5-15.0 |
| Impact resistance Izod, kJ/m², across | 0.8-10.0 |
| Density, kg/m³ | 1200-2000 |
| Thermal conductivity, along, W/(m · K) | 0.30-0.55 |
| Thermal conductivity, across, W/(m · K) | 0.30-0.55 |
| Coefficient of linear thermal expansion | 15 · 10⁻⁶-50 · 10⁻⁶ |
| (CLTE), along, ×10⁻⁶ ° C.⁻¹ | |
| Coefficient of linear thermal expansion | 20 · 10⁻⁶-50 · 10⁻⁶ |
| (CLTE), across, ×10⁻⁶ ° C.⁻¹ | |
| Paint adhesion strength, MPa | 1.5-4.0 |
| Warpage, mm | 0-6 |

The disclosed materials can comprise a base organic matrix (e.g., resin) that can include one or more acrylate oligomers and/or acrylate monomers, and also one or more photoinitiators, fillers, flame retardants, additives, chopped fibers, and/or processing aids.

The resin can provide fluidity in the composition to facilitate 3D printing, as well as desirable characteristics such as high strength, plasticity, impact resistance, and low thermal conductivity in the printed construction material.

One or more fillers can contribute to high elastic modulus, strength, low coefficient of thermal expansion, and low shrinkage in the 3D-printed construction material. The one or more fillers may not precipitate during the printing process due to the high viscosity of the resin and the use of thixotropic additives, ensuring a homogeneous composition. During lengthy storage times of 6 months or more, the one or more fillers can precipitate but the composition can remain easily recoverable.

One or more flame retardants can improve fire resistance to photopolymer composite construction material. One or more additives can improve the technological properties of the composition and durability of the composite material. One or more chopped fibers can provide low warping of printed parts and reduce the risk of cracking. One or more processing aids can improve rheological characteristics of the material and promote chopped fiber orientation.

The present disclosure also relates to various production methods of composite construction 3D printing material having a composition. The methods can include combining acrylate oligomer(s) in a range between about 0-30.0 wt % of the composition, acrylate monomer(s) in a range between about 0-30.0 wt % of the composition, photoinitiator(s) in a range between about 0.02-1.0 wt % of the composition, chopped fiber(s) in a range between about 0.1-3.0 wt % of the composition, flame retardant(s) in a range between about 2.0-20.0 wt % of the composition, processing aid(s) in a range between about 0.05-3.00 wt % of the composition, filler(s) in a range between about 20.0-80.0 wt % of the composition, and additive(s) in a range between about 0-3.0 wt % of the composition. The methods can further include producing 3D printing photopolymer composition by blending these composition components.

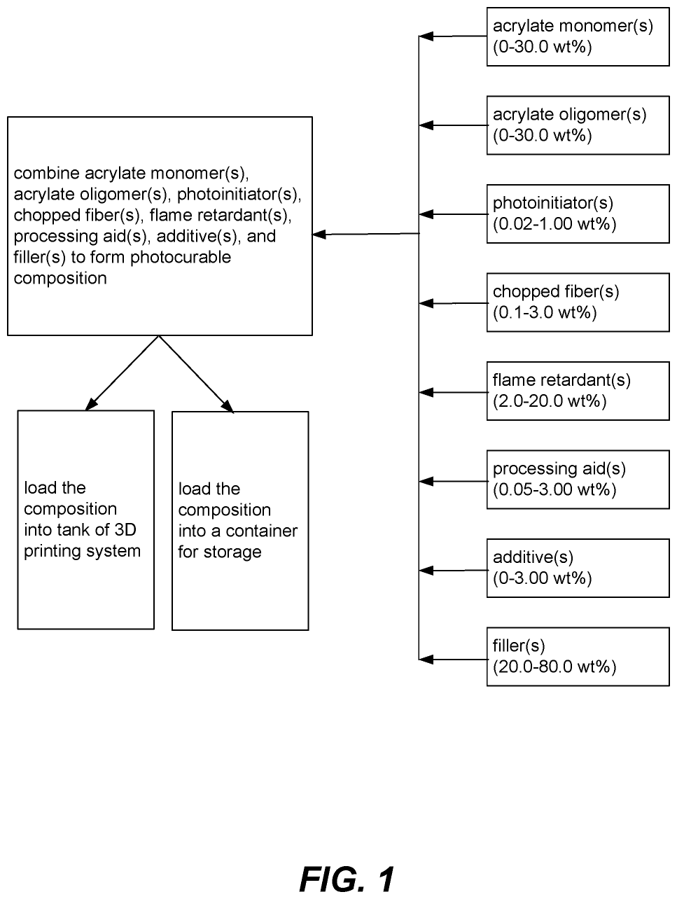

FIG. 1 illustrates representative groups of components of 3D printing construction material and major production steps according to one embodiment of the present disclosure. The disclosed 3D printing photopolymer composition can include one or more acrylate oligomer(s), acrylate monomer(s), photoinitiator(s), flame retardant(s), filler(s), additive(s), chopped fiber(s), and processing aid(s), as shown in FIG. 1.

The acrylate oligomer(s) can provide a desired viscosity of a composition, low shrinkage, and provide desirable mechanical properties for construction material. In some embodiments of a composition, the acrylate oligomer(s) can include bisphenol A epoxy diacrylate. Bisphenol A epoxy diacrylate, a bifunctional acrylate oligomer, is a transparent liquid with high viscosity. A bisphenol A epoxy diacrylate can range between about 0-30 wt % (such as 8-15 wt %) of the composition. The bisphenol A epoxy diacrylate can provide high reactivity, chemical resistivity, and high rigidity to the cured material. Some properties of Bisphenol A epoxy diacrylate are found in Table 2.

TABLE 2
Bisphenol A epoxy diacrylate

| Parameter | Value |
|---|---|
| Density at 25° C., kg/m³ | 1170 |
| Viscosity at 25° C., mPa · s | 400 000-600 000 |
| Viscosity at 60° C., mPa · s | 2000-4000 |
| Refractive Index, unit | 1.557 |
| Acid value, mg KOH/g | ≤2 |
| Epoxy content, % | ≤0.5 |
| Functionality, theoretical | 2 |

In some embodiments of a composition, acrylate oligomer(s) can include modified bisphenol A epoxy diacrylate. Modified bisphenol A epoxy diacrylate, a bifunctional acrylate oligomer, is a transparent liquid with high viscosity. A modified bisphenol A epoxy diacrylate can range between about 0-30 wt % (such as 10-15 wt %) of the composition. The modified bisphenol A epoxy diacrylate can provide improved flexibility to the cured material. Some properties of Modified Bisphenol-A-epoxy diacrylate are found in Table 3.

TABLE 3
Modified Bisphenol A epoxy diacrylate

| Parameter | Value |
|---|---|
| Density at 25° C., kg/m³ | 1090 |
| Viscosity at 25° C., mPa · s | 20 000-30 000 |
| Viscosity at 60° C., mPa · s | 400-700 |
| Refractive Index, unit | 1.533 |
| Acid value, mg KOH/g | ≤3 |
| Epoxy content, % | ≤0.5 |
| Functionality, theoretical | 2 |

In some embodiments, acrylate oligomer(s) can include polyester acrylate. Polyester acrylate can range between about 0-30 wt % (such as 8-15 wt %) of a composition. Polyester acrylate can provide good abrasion resistance, solvent resistance, and hardness. Additional and/or alternative acrylate oligomers can be used, including different types such as polyurethane acrylate, polyether acrylate, including oligomers based on renewable resources such as epoxidized soya oil acrylates, alone or in any suitable combination. Any suitable single acrylate oligomer or combination of acrylate oligomers can be used.

In some embodiments, acrylate monomer(s) can range between about 0-30 wt % of a composition. The acrylate monomer(s) can provide a desirable viscosity and reactivity for the composition. Desirable fluidity of composition as well as resistance to filler sedimentation are largely determined by the viscosity of the resin, which in this application can include at least one or more acrylic oligomers, one or more acrylic monomers, or both.

In general, the resin viscosity of a composition can range between about 50-10,000 mPa·s, such as 150-500 mPa·s, at 25° C. The type of acrylate oligomer(s) and/or acrylate monomer(s), as well as their ratio(s), can determine properties of both the resin itself and the entire composition. Increasing the acrylate oligomer/acrylate monomer ratio can lead to increasing resin viscosity and a decrease in shrinkage. The resin can be composed entirely of one component of acrylate oligomer or one component of acrylate monomer if such one component has the desired characteristics.

In some embodiments, an acrylate monomer can include tripropylene glycol diacrylate. Tripropylene glycol diacrylate is a low-viscosity transparent liquid that serves as a reactive diluent when mixed with an acrylate oligomer, providing the desired resin viscosity and increasing the reactivity of the resin. Tripropylene glycol diacrylate content in a composition can range between about 0-30 wt % of the composition. Some properties of tripropylene glycol diacrylate are found in Table 4.

TABLE 4
Tripropylene glycol diacrylate

| Parameter | Value |
|---|---|
| Density at 25° C., kg/m³ | 1020-1040 |
| Viscosity at 25° C., mPa · s | 10-15 |
| Refractive Index, unit | 1.450 |
| Molecular Weight, g/mol | 300 |

In some embodiments, tripropylene glycol diacrylate can be partially or entirely replaced by other difunctional (meth)acrylate monomers, such as dipropylene glycol diacrylate, triethylene glycol dimethacrylate, neopentyl glycol propoxylate diacrylate, 1,6-hexanediol diacrylate, hydroxypivalic acid neopentyl glycol diacrylate, tricyclodecanediol diacrylate, and polyethylene glycol diacrylate, for example. In some embodiments, tripropylene glycol diacrylate can be partially or completely replaced by monofunctional (meth)acrylate monomers such as isobornyl acrylate, hydroxyethyl methacrylate, 4-tert-butylcyclohexyl acrylate, phenoxyethyl acrylate, and monofunctional epoxy acrylate, for example. In some embodiments, tripropylene glycol diacrylate can be partially or completely replaced by multifunctional (meth)acrylate monomer with functionality 3 and above such as trimethylolpropane triacrylate, trimethylolpropane ethoxy triacrylate, acrylated glycerol derivative, and pentaerythritol tetraacrylate, for example. Any suitable single acrylate monomer or combination of acrylate monomers can be used.

Photoinitiators are compounds producing free radicals when exposed to UV or visible light. The radicals generated by UV or visible light can initiate the polymerization of acrylate oligomers and acrylate monomers, which leads to the curing of the composition. One or more photoinitiators can range between about 0.02-1.0 wt % of a composition. A photoinitiator concentration of less than 0.02 wt % can lead to a significant decrease in cure rate, reduced conversion, and interlayer adhesion, which can lead to delamination during printing and following lifetime operation. A photoinitiator concentration above 1.0 wt % can cause a decrease in strength of a construction material formed by 3D printing a composition material.

In some embodiments, photoinitiator(s) in a composition can include Type I photoinitiator(s). Type I photoinitiators are unimolecular free-radical generators; upon the absorption of UV or visible light, a specific bond within the structure of the photoinitiator undergoes homolytic cleavage to produce free radicals.

In some embodiments, a Type I photoinitiator used can be phosphine-type photoinitiators such as phenylbis(2,4,6-trimethylbenzoyl)phosphine oxide, diphenyl(2,4,6-trimethyl benzoylphosphine oxide, and ethyl (2,4,6-trimethylbenzoyl) phenyl phosphinate. The use of phenylbis(2,4,6-trimethylbenzoyl)phosphine oxide as a photoinitiator can provide greater depth of the composition curing and curing rate. Phenylbis(2,4,6-trimethylbenzoyl)phosphine oxide can range between about 0.02-0.5 wt % of a composition. Some properties of Phenylbis(2,4,6-trimethylbenzoyl)phosphine oxide are found in Table 5.

TABLE 5
Phenylbis(2,4,6-trimethylbenzoyl)phosphine oxide

| Parameter | Value |
|---|---|
| Density at 25° C., kg/m³ | 1170 |
| Form | White to Yellow to Green |
| | powder to crystalline |
| Molecular Weight, g/mol | 418 |
| Acid value, mg KOH/g | ≤0.20 |
| Melting point, ° C. | 131-135 |

In some embodiments, photoinitiator(s) in a composition can include Type II photoinitiator(s), such as benzophenone and its derivatives, 2-isopropylthioxanthone, and 2,4-diethylthioxanthone. Type II photoinitiators absorb UV or visible light to form excited molecules which then abstract an electron or hydrogen atom from a donor molecule (synergist, co-initiator), usually alcohol or amine. The donor molecule then reacts with a monomer to initiate polymerization. In some embodiments, the combinations of any photoinitiators mentioned above, as photoinitiators Type I and Type II may be used. Any suitable single photoinitiator or combination of photoinitiators can be used.

To prevent combustion of 3D-printed construction materials formed from the various compositions disclosed herein, a composition can have at least 2.0 wt % of one or more flame retardants. In some embodiments, such flame retardant(s) can include monoammonium phosphate. Monoammonium phosphate with particle size between about 10-1000 μm can range between about 6.0-20.0 wt % of the composition. Some properties of monoammonium phosphate are found in Table 6.

TABLE 6
Monoammonium Phosphate

| Parameter | Value |
|---|---|
| N content, % | 12 ± 1 |
| P₂O₅ content, % | 61 ± 1 |
| pH (1% solution in water) | 4.5-4.7 |
| Particle size, μm | 10-1000 |

In some embodiments, ammonium polyphosphate, a powder material with an average particle size of 10-30 μm, can be used as a highly effective flame retardant with low water solubility and high decomposition temperature. Ammonium polyphosphate can range between about 6.0-20.0 wt % of a composition.

In some embodiments, melamine and/or pentaerythritol, together known as flame retardants or flame retardants synergists, can be used as flame retardants or flame retardant synergists. Melamine, pentaerythritol, or a combination of both melamine and pentaerythritol can range between about 0.5-10.0 wt % of a composition.

In some embodiments, brominated or chlorinated organic compounds, known as halogenated flame retardants, can be used as flame retardants. Halogenated flame retardants can range between about 2.0-10.0 wt % of a composition. Any suitable single flame retardant or combination of flame retardants can be used.

In general, fillers in a composition can increase elastic modulus and strength, reduce the coefficient of linear thermal expansion of the material, reduce shrinkage, and reduce the carbon footprint. Filler content in a composition can range between about 20-80 wt % of a composition. Excess filler content above 80 wt % of a composition can lead to a decrease in the flowability of a composition, such that it can become necessary to reduce the feed rate of a material having such a composition into a 3D printer to avoid flow breaks and the formation of air gaps in the material.

In some embodiments, one or more fillers can include glass beads. Glass beads are transparent particles of glass close to a spherical shape that contribute to good fluidity and substantial curing depth of a composition even with a high filler content as well as high rigidity and low coefficient of linear thermal expansion of the construction material. In some embodiments, glass beads can range between about 20-70 wt % of a composition. In various embodiments, the glass beads can have size(s) that vary between about 10-500 μm, and in some arrangements these glass beads can have a size of about 10-150 μm. In some embodiments, the glass beads can be treated with a coupling agent to increase adhesion to the resin. Some properties of glass beads with a coupling agent are found in Table 7.

TABLE 7
Glass Beads with a coupling agent

| Parameter | Value |
|---|---|
| Specific weight, g/cm³ | ~2.5 |
| Bulk weight, kg/l | ~1.5 |
| Particles size (>90%), μm | 10-150 |
| Roundness, % | >80 |
| Coupling agent | Not identified by the producer |

In some embodiments, glass beads can be partially or completely replaced with ground glass. The addition of ground glass to a composition can reduce carbon footprint and cost since ground glass can be made from waste. Ground glass particle size can vary between about 10 and 300 μm. In some embodiments, glass beads can be partially or completely replaced with polymer fillers to reduce the density and heat conductivity of the material. In some embodiments, glass beads can be partially or completely replaced with organic fillers from renewable raw materials, such as cellulose and wood flour, for example, to reduce density, heat conductivity, and carbon footprint of the material. In some embodiments, glass beads can be partially or completely replaced with quartz sand or desert sand to reduce cost and carbon footprint of the material.

In some embodiments, recycled 3D printed construction materials as set forth in the present disclosure can be used as a filler material that provides waste-free production and the possibility of recycling building structures after the end of an operating period, which can guarantee a decrease in carbon footprint. The particle size of the 3D printed construction material can vary between about 10 and 3000 μm, for example. Any suitable single filler or combination of fillers can be used.

The use of one or more chopped fibers in a composition can lead to warpage reduction and crack prevention. In some embodiments, such chopped fiber(s) can include chopped glass fiber(s). Chopped glass fiber content in a composition can range between about 0.1-3.0 wt % of a composition. Chopped glass fiber diameters can range from about 6 to 26 μm, and chopped glass fiber lengths can be about 1 to 6 mm. In some embodiments, chopped glass fiber(s) can be used with a sizing. If the fiber is sized, the amount of sizing may vary from 0.1 to 2.5 wt % of chopped glass fiber. Some properties of chopped glass fiber are found in Table 8.

TABLE 8
Chopped glass fiber 24 μm

| Parameter | Value |
|---|---|
| Specific weight, g/cm³ | ~2.5 |
| Filament Diameter, μm | 24 |
| Chop Length, mm | 3.3 |
| Sizing, % | 1.25 |

In another embodiment, organic chopped fibers, such as polypropylene, polyamide, and polyacrylonitrile fibers, carbon fibers can be used as chopped fiber(s). In further embodiments, basalt fiber can be used as a chopped fiber(s). Any suitable single chopped fiber or combination of chopped fibers can be used.

Processing aids are substances that can improve the processability of a composition by reducing viscosity and friction between the composition and processing machinery, and by ensuring the solidity of the flow in combination with the optimal effect of its acceleration, thus ensuring flow integrity at the printing speeds used. Processing aids can ensure the orientation of chopped fiber in the direction of flow. In some embodiments, one or more processing aids can range between about 0.05-3.0 wt % of a composition.

In some embodiments, Methyl methacrylate copolymer butyl acrylate styrene, a white powder material with a density of 1.1 g/cm³, may be used as a highly effective processing aid. Methyl methacrylate copolymer butyl acrylate styrene can range between about 0.05-3.0 wt % of a composition. Any suitable single processing aid or combination of processing aids can be used in a given composition.

Additives are substances that can be added to a composition in small quantities to improve technological properties, storage stability, durability, and strengthening of the material, among other possible properties. In various embodiments of the present disclosure, additives can include rheology additives, in-can stabilizers, defoamers, dispersants, amine synergists, adhesion promoters, UV protectors, or any combination thereof.

In some embodiments, rheology additives can be used to improve the rheological properties of a composition and to prevent filler sedimentation and the formation of a dense precipitate during storage. In some embodiments, a rheology additive can be a thixotropic additive. Thixotropic additives can be used to increase storage stability and filler sedimentation resistance. Use of a thixotropic additive can lead to a significant increase in the viscosity of the composition at a low shear rate or at static conditions and can also prevent sedimentation of the filler during storage and processing. At the same time, as the shear rate increases during processing, the viscosity of the composition can decrease significantly. In some embodiments, a thixotropic additive can range between about 0-1.0 wt % of a composition.

In some embodiments, a thixotropic additive can include organically modified phyllosilicates. Such organically modified phyllosilicates can range between about 0-1.0 wt % of a composition. Some properties of organically modified phyllosilicates are found in Table 9.

TABLE 9
Organically modified phyllosilicates

| Parameter | Value |
|---|---|
| Form | Fine Powder |
| Moisture Content, % | <6 |
| Loss on ignition, % | 29-33 |
| Specific Gravity, kg/l | 1.5-1.7 |

In-can stabilizers are substances that can improve material stability by preventing polymerization during storage. In some embodiments, one or more in-can stabilizers can range between about 0-1.0 wt % of a given composition. Defoamers are substances that can limit the formation of bubbles in the process of manufacturing a composite material for 3D printing. In some embodiments, one or more defoamers can range between about 0-1.0 wt % of a given composition. Dispersants are substances that can improve dispersal of filler and flame-retardant particles. In some embodiments, one or more dispersants can range between about 0-1.0 wt % of a given composition.

Amine synergists are substances that can act synergistically with Type II photoinitiators producing a reactive alkyl-amino free radical. Amine synergists can also reduce oxygen inhibition of polymerization. In some embodiments, one or more amine synergists can range between about 0-1.0 wt % of a given composition. Adhesion promoters are substances that can improve adhesion of a construction material to other materials. In some embodiments, one or more adhesion promoters can range between about 0-1.0 wt % of a given composition to improve the adhesion of construction material to foam and coatings. UV protection additives are substances that can protect 3D construction material against UV exposure during the lifetime operation of a 3D printed construction. In some embodiments, one or more UV protection additives can range between about 0-1.0 wt % of a given composition to protect the construction material against UV exposure during operation.

A given composition can contain one, several, or all of the above additives at the same time, and other additives not set forth herein may alternatively or also be used. In some embodiments, a given composition can be prepared without additives. Furthermore, any suitable additive or combination of additives can be used in a given composition.

Various examples will now be provided, which examples are provided by way of illustration and not by way of limitation. These examples include compositions of materials that can include 3D printable photocurable materials, for example. Such materials can include photocurable warp-reducing composite materials that are configured for 3D printing of building structures. In various embodiments, the example materials with the disclosed compositions can have a viscosity of about 10,000-300,000 mPa·s, can be configured to be extruded at a printing speed of about 7-90 cm³/s during 3D printing, can be configured to be photopolymerized under UV or visible irradiation at a material depth of about 4-8 mm, and can be configured to be cured to form a building construction material. The material viscosity can provide appropriate flow properties and stability to sedimentation.

In addition, the choice of composition components can support all of the following favorable properties of a solidified final 3D-printed material having the disclosed compositions. Such properties can include:
paint adhesion strength of at least 1.5 MPa, to reliably protect building structures from the effects of weather factors;
tensile modulus of at least 3 GPa, to ensure rigidity of the building structure;
tensile strength of at least 5 MPa, to ensure safety of the building structure;
compression modulus of at least 2 GPa, to ensure rigidity of the building structure;
compression strength of at least 40 MPa, to ensure strength of the building structure;
density not exceeding 2000 kg/m3, to ensure low weight of the building structure and sound resistance;
thermal conductivity not exceeding 0.55 W/(m·K), to ensure thermal insulation properties of the building structure to maintain thermal comfort and microclimate inside buildings;
coefficient of linear thermal expansion not exceeding 50*10-6° C-1, to maintain integrity of the structure and prevent excessive deformations under temperature effects; and
impact resistance of at least 0.8 kJ/m², to ensure safety of the building structure.

Other favorable properties are also possible. The foregoing properties can be determined by a suitable test or process, such as, for example:
Paint adhesion strength can be measured using a pull-off test for adhesion, which measures the force required to pull a coating off a painted surface.
Tensile modulus can be the slope of the linear part of the stress-strain curve for a material under tension.
Tensile strength can be measured by a standard test in which a sample is subjected to a controlled tension until failure.
Compression modulus can be the slope of the linear part of the stress-strain curve for a material under compression.
Compression strength can be the stress at which a specimen breaks when the specimen is compressed.
Density can be determined by hydrostatic weighing (displacement method), which is based on measuring the difference in the weight of a sample in air and in a liquid with a known density.
Thermal conductivity can be determined by the heat source (hot disc) method, which is based on measuring the change in temperature of a sensor built into a sample after the pulsed generation of a thermal pulse.
Coefficient of linear thermal expansion can be determined from the change in the size of a test sample with temperature using thermomechanical analysis equipment.
Impact resistance can be determined by the Izod impact resistance method, which involves determining the energy of a pendulum that is spent on the destruction of a sample during impact.

In various situations involving building construction, warping of 3D-printed building components or other items can raise concerns. Printing of structural elements up to 6 feet wide and 3.5 feet high without the use of continuous fiber reinforcing is typically possible with warping of no more than 6 mm. Warping of more than 6 mm can cause the formation of internal stresses leading to cracking, delamination, and technically unacceptable changes in component geometry. Accordingly, elimination or reduction of warping can be a desirable outcome when 3D printing building components or other items.

Overall warpage can be determined by directly measuring the gap between the surface on which a sample is located and the bottom of the panel at the edges of the sample printed panel. In actual testing of a subject 3D-printed panel, two consecutive measurements were taken. Each measurement was carried out after the subject 3D-printed panel had cooled down to room temperature for about two hours.

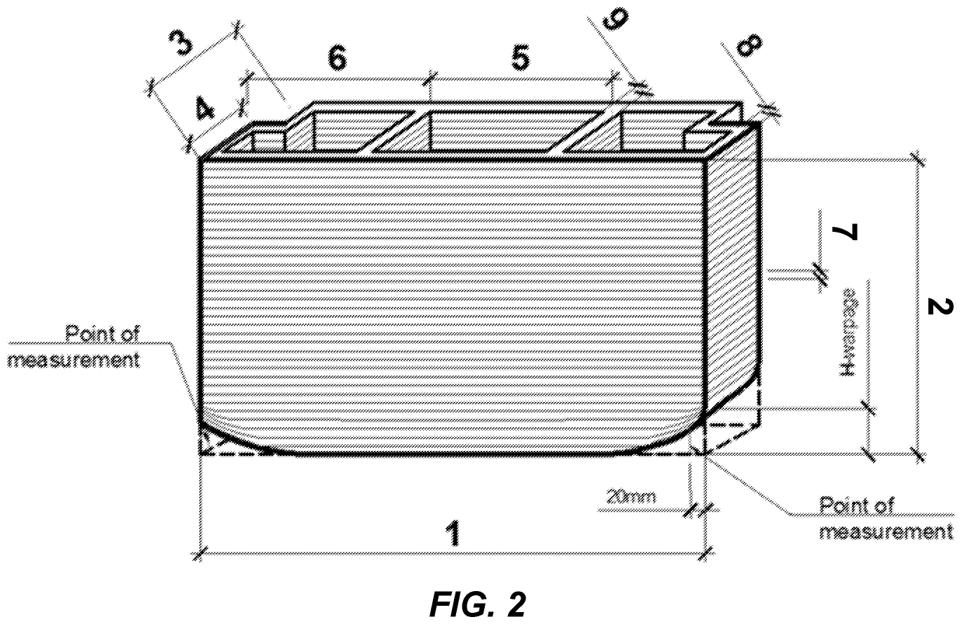

FIG. 2 illustrates in front perspective view an example 3D-printed panel configured for conducting warpage testing according to one embodiment of the present disclosure. Warping was determined by the distance of the gap from the plane on which the sample was located to the measurement point to the point 20 mm away from the edge in each of the two corners. The final value of the warpage was calculated as the average of two warpage values measured on each side of the panel. As shown in FIG. 2, various measurements of the example panel can be at or about: 1—length of 920±3 mm, 2—height of at least 440 mm, 3—total ridge of 185±3 mm, 4—width of 110±3 mm, 5—distance between infills of 280±3 mm, 6-280±3 mm. 7—layer height of 5 mm, 8—layer width of 12±3 mm, and 9—infill width of 24 mm.

Various composite formulations that are the subject of the present disclosure and that are set forth in the given examples herein provide favorable properties for 3D printing construction materials, such as, for example, a viscosity of about 10,000-300,000 mPa·s, which can provide appropriate flow properties and stability to sedimentation, an ability to be printed (e.g., configured to be extruded) at printing speeds of about 7-90 cm³/s during 3D printing, an ability to be photopolymerized under UV or visible irradiation at a material depth of about 4-8 mm, and an ability to be cured to form a building construction material. Other favorable properties are also possible.

### EXAMPLE 1

Table 10 provides components and quantities of example Formulation #1 for a composite material for use in 3D printing additive manufacturing.

TABLE 10
Formulation #1

| Ingredient | wt % | Function |
|---|---|---|
| Tripropylene glycol diacrylate | 13.0 | Acrylate monomer |
| Modified bisphenol A epoxy diacrylate | 13.0 | Acrylate oligomer |
| Glass Beads with a coupling agent | 62.721 | Filler |
| Monoammonium phosphate | 10.1 | Flame retardant |
| Phenylbis(2,4,6-trimethylbenzoyl) | 0.078 | Photoinitiator |
| phosphine oxide | | |
| Chopped glass fiber 3 mm | 0.65 | Chopped fiber |
| Methyl methacrylate copolymer | 0.351 | Processing aid |
| butyl acrylate styrene | | |
| Organically modified phyllosilicates | 0.1 | Thixotropic |
| | | additive |

Table 11 shows some resulting properties of Formulation #1.

TABLE 11
Properties of Formulation #1

| Parameter | Value |
|---|---|
| Flexural modulus of elasticity, along, GPa | 6.7 |
| Flexural ultimate strength, along, MPa | 33.4 |
| Flexural modulus of elasticity, across, GPa | 6.0 |
| Flexural ultimate strength, across, MPa | 21.6 |
| Tensile modulus, along, GPa | 7.9 |
| Tensile strength, along, MPa | 14.1 |
| Tensile modulus, across, GPa | 7.9 |
| Tensile strength, across, MPa | 7.3 |
| Compression modulus, along, GPa | 5.8 |
| Compression strength, along, MPa | 56.4 |
| Compression modulus, across, GPa | 5.5 |
| Compression strength, across, MPa | 48.7 |
| Impact resistance Izod, along, kJ/m² | 3.4 |
| Impact resistance Izod, across, kJ/m² | 0.9 |
| Density, kg/m³ | 1820 |
| Thermal conductivity, along, W/(m · K) | 0.51 |
| Thermal conductivity, across, W/(m · K) | 0.42 |
| Warpage, mm | 3.0 |

All parameters of Formulation #1 meet the foregoing desirable material qualities and properties for a composite material for 3D printing of building structures.

### EXAMPLE 2

Table 12 shows the components and quantity Formulation #2. Formulation #2 differs from Formulation #1 in that the oligomer is Bisphenol A epoxy acrylate.

TABLE 12
Formulation #2

| Ingredient | wt % | Function |
|---|---|---|
| Tripropylene glycol diacrylate | 15.2 | Acrylate monomer |
| Bisphenol A epoxy diacrylate | 10.8 | Acrylate oligomer |
| Glass Beads with a coupling agent | 62.721 | Filler |
| Monoammonium phosphate | 10.1 | Flame retardant |
| Phenylbis(2,4,6-trimethylbenzoyl) | 0.078 | Photoinitiator |
| phosphine oxide | | |
| Chopped glass fiber 3 mm | 0.65 | Chopped fiber |
| Methyl methacrylate copolymer | 0.351 | Processing aid |
| butyl acrylate styrene | | |
| Organically modified phyllosilicates | 0.1 | Thixotropic |

Table 13 shows some resulting properties of Formulation #2.

TABLE 13
Properties of Formulation #2

| Parameter | Value |
|---|---|
| Flexural modulus of elasticity, along, GPa | 5.0 |
| Flexural ultimate strength, along, MPa | 27.0 |
| Flexural modulus of elasticity, across, GPa | 5.3 |
| Flexural ultimate strength, across, MPa | 19.9 |
| Tensile modulus, along, GPa | 6.5 |
| Tensile strength, along, MPa | 11.6 |
| Tensile modulus, across, GPa | 5.3 |
| Tensile strength, across, MPa | 6.9 |
| Compression modulus, along, GPa | 5.3 |
| Compression strength, along, MPa | 55.0 |
| Compression modulus, across, GPa | 4.8 |
| Compression strength, across, MPa | 54.6 |
| Density, kg/m3 | 1820 |
| Warpage, mm | 4.0 |

All parameters of Formulation #2 meet the foregoing desirable material qualities and properties for a composite material for 3D printing of building structures.

### EXAMPLE 3

Table 14 shows the components and quantity Formulation #3. Formulation #3 differs from Formulation #1 in that the amount of chopped fiber decreased from 0.65 to 0.325 wt %.

TABLE 14
Formulation #3

| Ingredient | wt % | Function |
|---|---|---|
| Tripropylene glycol diacrylate | 13.0 | Acrylate monomer |
| Modified bisphenol A epoxy diacrylate | 13.0 | Acrylate oligomer |
| Glass Beads with a coupling agent | 63.136 | Filler |
| Monoammonium phosphate | 10.1 | Flame retardant |
| Phenylbis(2,4,6-trimethylbenzoyl) | 0.079 | Photoinitiator |
| phosphine oxide | | |
| Chopped glass fiber 3 mm | 0.325 | Chopped fiber |
| Methyl methacrylate copolymer | 0.26 | Processing aid |
| butyl acrylate styrene | | |
| Organically modified phyllosilicates | 0.1 | Thixotropic |
| | | additive |

Table 15 shows some resulting properties of Formulation #3.

TABLE 15
Properties of Formulation #3

| Parameter | Value |
|---|---|
| Flexural modulus of elasticity, along, GPa | 7.0 |
| Flexural ultimate strength, along, MPa | 27.9 |
| Flexural modulus of elasticity, across, GPa | 4.9 |
| Flexural ultimate strength, across, MPa | 15.2 |
| Tensile modulus, along, GPa | 5.6 |
| Tensile strength, along, MPa | 10.5 |
| Tensile modulus, across, GPa | 5.4 |
| Tensile strength, across, MPa | 7.3 |
| Warpage, mm | 5.0 |

Referring to Tables 12 and 15 to compare the properties of Formulations #1 and #3, decreasing the amount of chopped fiber from 0.65 in Formulation #1 to 0.325 in Formulation #3 led to a slight increase in warpage. Nevertheless, all parameters of Formulation #3 meet the foregoing desirable material qualities and properties for a composite material for 3D printing of building structures. Of course, other suitable formulations are also possible.

As noted above, the present disclosure also includes various methods of producing a 3D printable photocurable material. This can involve preparation of novel compositions of 3D printing material by mixing the composition components in a container. In some embodiments, a mixer or any other suitable container with a stirrer can be used for mixing, blending, or otherwise combining the composition components. In some arrangements, composition components can be combined in the following order: acrylate monomer(s), photoinitiator(s), chopped fiber(s), acrylate oligomer(s), flame retardant(s), processing aid(s), additive(s), and filler(s). Other orders for combining the materials may also be used in alternative arrangements.

Various methods of generating a formulation of the photopolymer composite material for use in a 3D printing system can involve combining acrylate oligomer(s) in a range between about 0-30.0 wt % of the composition, acrylate monomer(s) in a range between about 0-30.0 wt % of the composition, photoinitiator(s) in a range between about 0.02-1.00 wt % of the composition, chopped fiber(s) in a range between about 0.1-3.0 wt % of the composition, flame retardant(s) in a range between about 2.0-20.0 wt % of the composition, processing aid(s) in a range between about 0.05-3.00 wt % of the composition, additive(s) in a range between about 0-3.0 wt % of the composition, and filler(s) in a range between about 20.0-80.0 wt % of the composition. These components can be combined and mixed in a container. All components can be weighed with a specified accuracy of at least 1% of their weight. In some embodiments, the disclosed methods can include producing a resin composite by blending or otherwise combining a subset of all of the components of the composition.

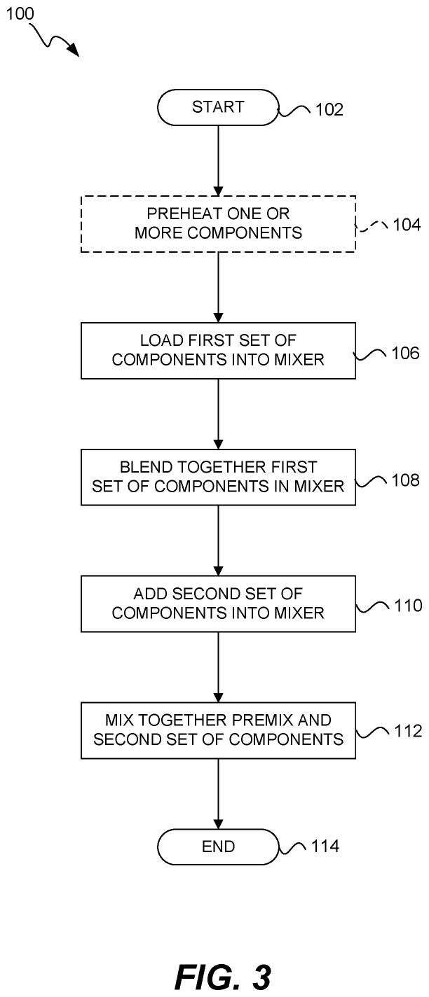

FIG. 3 illustrates a flowchart of one example method of producing a 3D printable photocurable material according to one embodiment of the present disclosure. It will be readily appreciated that method 100 can be a high level method such that one or more steps can be omitted, various other steps can be added, and/or the order of steps can be altered as may be desired. After a start step 102, an optional first process step 104 can involve preheating one or more components to be used in producing the 3D printable photocurable material. This can include, for example, preheating one or more acrylate oligomers at 30-60° C., such as to decrease the viscosity of a composition during production or to decrease the viscosity of the acrylate oligomer(s) to facilitate pumping. One or more other components can alternatively or also be preheated as may be desired. This can be done automatically and can take place at a designated preheating container, along a stream of material as it is being pumped, or at any other suitable region of an overall production system.

At the next process step 106, a first plurality or set of components can be loaded into a mixing device. The first plurality or set of components can include multiple components to be used in producing the 3D printable photocurable material, such as, for example, at least one or more acrylate monomers and one or more photoinitiators. One or more additional and/or alternative components can be included in this first set of components. Loading the first set of components can be done automatically and can take place in any suitable mixing device.

At the following process step 108, the first plurality or set of components can be blended together in the mixing device to form a premix. Any suitable way of blending the first set of components together can be done. This blending can be accomplished, for example, by using a mixer having a stirring component, among other possible ways to blend the first set of components together. Step 108 can be done automatically in some embodiments.

Subsequent process step 110 can involve adding a second plurality or set of components to the premix in the mixing device. The first plurality of components and second plurality of components combined can include one or more acrylate monomers, photoinitiators, acrylate oligomers, chopped fibers, flame retardants, processing aids, additives, and/or fillers, in any combination, and the second plurality or set of components can include any of these components that were not included in the first plurality of set of components. Adding the second set of components can be done automatically in some embodiments.

Process step 112 can involve mixing together the premix and the second plurality of components in the mixing device to form a 3D printable photocurable material having a composition as set forth in detail herein. Any suitable way of mixing together the premix and the second set of components can be done, such as, for example, by using a mixer having a stirring component. Mixing together the premix and the second set of components can be done automatically in some embodiments. In some arrangements, steps 110 and 112 can be performed simultaneously, and in some arrangements the overall method can alternate back and forth between steps 110 and 112 as one or more new and separate components are added to an intermediate mixture of some of the components during the overall process. The order of adding and mixing components can vary as desired. The method can then end at end step 114.

In various embodiments, some or all steps can be performed simultaneously and in automated fashion, such that one or multiple compositions of material of the same or different types can be produced at the same time. In addition, not all steps will be needed for some production methods, and the order of steps can be altered as may be practical or optimal for a given production method. Additional possible steps or functions can also be performed as may be desired. Examples of such additional steps and details of these and the foregoing steps will now be provided, and it will be readily appreciated that some or all of these additional steps and/or details may be applied to a given production method.

In some embodiments, an ongoing or intermediate mixture can be thoroughly stirred or otherwise mixed during or after loading each component of the composition into a mixer, stirrer, or other suitable mixing device. Stirring or mixing can be continuous as one or more new components are added or can be paused during the introduction of one or more new components. For example, after loading (i.e., adding) the photoinitiator(s) into the mixing device, the mixture can be stirred (or otherwise mixed) for about 1-5 minutes at a stirrer speed of about 20-1000 rpm. After loading the chopped fiber(s), stirring can continue for about 1-20 minutes at a stirrer speed of about 1-200 rpm. After loading the acrylate oligomer(s), stirring can continue for about 1-30 minutes at a stirrer speed of about 1-200 rpm. In some embodiments, this stage can be eliminated if mixing or stirring was carried out during loading of the acrylate oligomer(s).

After loading the flame retardant(s) into the mixer or other mixing device, stirring can continue for about 1-30 minutes at a stirrer speed of about 1-1000 rpm. In some embodiments, this stage can be eliminated if mixing or stirring was carried out during loading of the flame retardant(s). After loading the processing aid(s) into the mixer, the stirring can continue for about 1-30 minutes at a stirrer speed of 10-1000 rpm. In some embodiments, the filler(s) can be loaded into the mixer with stirring at a speed of about 10-100 rpm. After loading the flame retardant(s), stirring can continue for about 1-10 minutes at a stirrer speed of about 10-1300 rpm. One or more additives can be added at any stage of the process. In some embodiments, additives can be introduced in the form of prefabricated concentrates in the acrylate monomer(s) or an acrylate monomer/acrylate oligomer blend.

In some embodiments, loading of the composition components can be in an altered order. For example, filler(s) can be loaded into the mixing device after flame retardant(s). Photoinitiator(s) can be loaded at any step of loading the components in some arrangements. Moreover, photoinitiator(s) can be loaded in dry form and/or in the form of a pre-prepared solution in the acrylate monomer(s) with a concentration of up to 2.5 wt %. In addition, or in an alternative embodiment, one or more liquid photoinitiators may be used.

In some embodiments, a powder flame retardant and/or a powder filler may be mixed with the acrylate monomer(s) first and then the acrylate oligomer(s) may be added to the mixture. Furthermore, stirring or other type of mixing may be started after loading several components at once rather than one component at a time at any given stage. In some embodiments, one stage of acrylate oligomer(s) can be preheated to 30-60° C. to facilitate reducing material viscosity and to facilitate pumping material into the mixing device and/or any other production system device. One or more other components can also be preheated as desired.

In some arrangements, the stirring or otherwise mixing of the components can be carried out sequentially in two or more mixers. For example, the dissolving of photoinitiator(s) in acrylate monomer(s), or mixing of acrylate monomer(s), photoinitiator(s), additive(s), chopped fiber(s), processing aid(s) and/or flame retardant(s) can be carried out in a first mixer having a high-speed stirrer such as a turbine, propeller, or dissolver stirring component. The resulting solution or suspension can then be pumped into a second mixer for mixing with one or more fillers and/or other components by using a slow-speed stirrer such as an anchor type stirrer.

### EXAMPLE 4

One specific example of a detailed production method will now be provided. It will be understood that this specific example is provided by way of illustration and not by way of limitation. The following method for making a composition can include mixing the various detailed components set forth below at a temperature ranging between about 20-25° C.

For the example method of producing a 3D printable photocurable material detailed here, two mixers were used. Mixer 1 with a volume of 0.35 m³ was equipped with weighing cells with an accuracy of 0.5 kg and a dissolver stirrer. Mixer 2 with a volume of 1.0 m³ was equipped with weighing cells with an accuracy of 1.0 kg as well as anchor and propeller stirrers. 195 kg (13.0 wt % of the composition) tripropylene glycol diacrylate was pumped into Mixer 1. 1170 g (0.078 wt % of the composition) phenylbis(2,4,6-trimethylbenzoyl)phosphine oxide pre-weighed on a balance with an accuracy of 1 g was added to the tripropylene glycol diacrylate. The mixture was stirred for 5 minutes at a stirrer speed of 50 rpm to dissolve the phenylbis(2,4,6-trimethylbenzoyl)phosphine oxide in tripropylene glycol diacrylate, after which the solution of phenylbis(2,4,6-trimethylbenzoyl)phosphine oxide in tripropylene glycol diacrylate was pumped from Mixer 1 into Mixer 2. 9.75 kg (0.65 wt % of the composition) chopped glass fiber was loaded into Mixer 2 within 7 minutes with stirring at an anchor stirrer speed of 4 rpm. 195 kg (13.0 wt % of the composition) modified bisphenol A epoxy diacrylate was pumped into Mixer 2 within 20 minutes with stirring at an anchor stirrer speed of 10 rpm. 151.5 kg (10.1 wt % of the composition) monoammonium phosphate was loaded into Mixer 2 within 5 minutes with stirring at an anchor stirrer speed of 10 rpm. After loading the monoammonium phosphate, stirring continued at an anchor stirrer speed of 20 rpm and propeller stirrer speed of 600 rpm for 20 minutes. Before use, monoammonium phosphate was sifted through a sieve with a mesh size of 1.0 mm. 5.265 kg (0.351 wt % of the composition) of processing aid was loaded into Mixer 2 within 9 minutes with stirring at an anchor stirrer speed of 20 rpm and propeller stirrer speed of 600 rpm. After loading the processing aid, the stirring continued at an anchor stirrer speed of 20 rpm and propeller stirrer speed of 600 rpm for 20 minutes. Thereafter, 1.5 kg (0.1 wt % of the composition) organically modified phyllosilicates were loaded into Mixer 2 within 2 minutes with stirring at an anchor stirrer speed of 20 rpm and a propeller stirrer speed of 600 rpm. Thereafter, 941 kg (62.72 wt % of the composition) of glass beads with a coupling agent were loaded into Mixer 2 within 12 minutes with stirring at an anchor stirrer speed of 25 rpm and a propeller stirrer speed of 1300 rpm. After loading the glass beads, the stirring continued for 35 minutes, after which the resulting composition was pumped into barrels in its final material formation.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1. A composition of 3D printable photocurable material, the composition comprising:
one or more acrylate monomers in a range between about 0-30.0 wt % of the composition;
one or more acrylate oligomers in a range between about 0-30.0 wt % of the composition;
one or more photoinitiators in a range between about 0.02-1.0 wt % of the composition;
one or more chopped fibers in a range between about 0.1-3.0 wt % of the composition;
one or more flame retardants in a range between about 2.0-20.0 wt % of the composition;
one or more processing aids in a range between about 0.05-3.0 wt % of the composition;
one or more additives in a range between about 0-3.0 wt % of the composition; and
one or more fillers in a range between about 20.0-80.0 wt % of the composition, wherein the composition has a viscosity of about 10,000-300,000 mPa·s, is configured to be extruded at a printing speed of about 7-90 cm³/s during 3D printing, is configured to be photopolymerized under UV or visible irradiation at a material depth of about 4-8 mm, and is configured to be cured to form a building construction material.

2. The composition of claim 1, wherein the one or more acrylate oligomers includes bisphenol A epoxy diacrylate.

3. The composition of claim 1, wherein the one or more acrylate oligomers includes modified bisphenol A epoxy diacrylate.

4. The composition of claim 1, wherein the one or more acrylate monomers includes tripropylene glycol diacrylate.

5. The composition of claim 1, wherein the one or more acrylate monomers includes monofunctional (meth)acrylate, difunctional (meth)acrylate, multifunctional (meth)acrylate, or any combination thereof.

6. The composition of claim 1, wherein the one or more photoinitiators includes phenylbis(2,4,6-trimethylbenzoyl)phosphine oxide.

7. The composition of claim 6, wherein the phenylbis(2,4,6-trimethylbenzoyl)phosphine oxide is in a range between about 0.02-0.5 wt % of the composition.

8. The composition of claim 1, wherein the one or more photoinitiators includes a Type I photoinitiator.

9. The composition of claim 1, wherein the one or more photoinitiators includes a Type II photoinitiator.

10. The composition of claim 1, wherein the one or more photoinitiators includes Type I and Type II photoinitiators in combination.

11. The composition of claim 1, wherein the one or more flame retardants includes monoammonium phosphate.

12. The composition of claim 11, wherein the monoammonium phosphate is in a range between about 6.0-20.0 wt % of the composition.

13. The composition of claim 1, wherein the one or more flame retardants includes ammonium polyphosphate.

14. The composition of claim 13, wherein the ammonium polyphosphate is in a range between about 6.0-20.0 wt % of the composition.

15. The composition of claim 1, wherein the one or more fillers include glass beads.

16. The composition of claim 15, wherein the glass beads are in a range between about 20-70 wt % of the composition.

17. The composition of claim 15, wherein the glass beads are treated with a coupling agent to increase adhesion to a resin of the composition, the resin including at least one of the one or more acrylate monomers and the one or more acrylate oligomers.

18. The composition of claim 1, wherein the one or more fillers include polymer fillers, organic fillers, quartz sand, desert sand, grinded glass, recycled 3D printed construction material, or any combination thereof

19. The composition of claim 1, wherein the one or more chopped fibers include chopped glass fibers.

20. The composition of claim 19, wherein the chopped glass fibers are in a range between about 0.1-3 wt % of the composition.

21. The composition of claim 19, wherein the chopped glass fibers have a length of about 1-6 mm.

22. The composition of claim 19, wherein the chopped glass fibers are treated with sizing to increase adhesion to a resin of the composition, the resin including at least one of the one or more acrylate monomers and the one or more acrylate oligomers.

23. The composition of claim 1, wherein the one or more chopped fibers includes polypropylene fibers, chopped polyamide fibers, chopped polyacrylonitrile fibers, chopped carbon fibers, chopped basalt fibers, or any combination thereof.

24. The composition of claim 1, wherein the one or more processing aids includes Methyl methacrylate copolymer butyl acrylate styrene.

25. The composition of claim 24, wherein the Methyl methacrylate copolymer butyl acrylate styrene is in a range between about 0.05-3.0 wt % of the composition.

26. The composition of claim 1, wherein the one or more processing aids includes fluorinated polymers, wax additives, or any combination thereof.

27. The composition of claim 1, wherein the one or more additives include rheology additives, in-can stabilizers, defoamers, dispersants, amine synergists, adhesion promoters, UV protectors, or any combination thereof.

28. The composition of claim 27, wherein the rheology additives include a thixotropic additive.

29. The composition of claim 1, wherein the composition is configured to be cured to form a building construction material having a paint adhesion strength of at least 1.5 MPa.

30. The composition of claim 1 wherein the composition is configured to be cured to form a building construction material having a tensile modulus of at least 3 GPa.

31. The composition of claim 1 wherein the composition is configured to be cured to form a building construction material having a compression modulus of at least 2 GPa.

32. The composition of claim 1, wherein the composition is configured to be cured to form a building construction material having a tensile strength of at least 5 MPa.

33. The composition of claim 1, wherein the composition is configured to be cured to form a building construction material having a compression strength of at least 40 MPa.

34. The composition of claim 1, wherein the composition is configured to be cured to form a building construction material having a density of about 1200-2000 kg/m³.

35. The composition of claim 1, wherein the composition is configured to be cured to form a building construction material having a warpage of not more than about 6 mm.

36. A method of producing a 3D printable photocurable material, the method comprising:
loading a first plurality of components into a mixing device, wherein the first plurality of components includes at least one or more acrylate monomers, one or more acrylate oligomers, or both;
blending together the first plurality of components in the mixing device to form a premix;
adding a second plurality of components to the premix in the mixing device, wherein the first plurality of components and second plurality of components combined includes at least the one or more acrylate monomers, one or more acrylate oligomers, or both, the one or more photoinitiators, one or more chopped fibers, one or more flame retardants, one or more processing aids, one or more additives, and one or more fillers; and
mixing together the premix and the second plurality of components in the mixing device to form a 3D printable photocurable material having a composition, wherein the one or more acrylate monomers are in a range between about 0-30.0 wt % of the composition, the one or more photoinitiators are in a range between about 0.02-1.0 wt % of the composition, the one or more acrylate oligomers are in a range between about 0-30.0 wt % of the composition, the one or more chopped fibers are in a range between about 0.1-3.0 wt % of the composition, the one or more flame retardants are in a range between about 2.0-20.0 wt % of the composition, the one or more processing aids are in a range between about 0.05-3.0 wt % of the composition, the one or more additives are in a range between about 0-3.0 wt % of the composition, and the one or more fillers are in a range between about 20.0-80.0 wt % of the composition.

37. The method of claim 36, wherein the blending involves stirring the first plurality of components in the mixing device for about 1-5 minutes at a stirrer speed of about 20-1000 rpm.

38. The method of claim 36, wherein the one or more chopped fibers are added into the mixing device before at least one of the other second plurality of components are added into the mixing device to form a resulting mixture, and further comprising the step of:
stirring the resulting mixture for about 1-20 minutes at a stirrer speed of about 1-200 rpm during or after adding the one or more chopped fibers.

39. The method of claim 36, wherein the one or more acrylate oligomers are added into the mixing device before at least one of the other second plurality of components are added into the mixing device to form a resulting mixture, and further comprising the step of:
stirring the resulting mixture for about 1-30 minutes at a stirrer speed of about 20-200 rpm during or after adding the one or more acrylate oligomers.

40. The method of claim 36, wherein the one or more flame retardants are added into the mixing device before at least one of the other second plurality of components are added into the mixing device to form a resulting mixture, and further comprising the step of:
stirring the resulting mixture for about 1-10 minutes at a stirrer speed of about 10-100 rpm during or after adding the one or more flame retardants.

41. The method of claim 36, wherein the one or more processing aids are added into the mixing device before at least one of the other second plurality of components are added into the mixing device to form a resulting mixture, and further comprising the step of:
stirring the resulting mixture for about 1-10 minutes at a stirrer speed of about 10-1000 rpm during or after adding the one or more processing aids.

42. The method of claim 36, wherein the one or more additives are added into the mixing device before at least one of the other second plurality of components are added into the mixing device to form a resulting mixture, and further comprising the step of:
stirring the resulting mixture for about 1-20 minutes at a stirrer speed of about 10-1300 rpm during or after adding the one or more additives.

43. The method of claim 36, wherein the one or more fillers are added into the mixing device before at least one of the other second plurality of components are added into the mixing device to form a resulting mixture, and further comprising the step of:
stirring the resulting mixture for about 1-20 minutes at a stirrer speed of about 10-1300 rpm during or after adding the one or more fillers.

44. The method of claim 36, further comprising the step of:
preheating the one or more acrylate oligomers at 30-60° C. to decrease viscosity.
